(19) United States
(12) Patent Application Publication
(10) Pub. No.: US 2025/0241369 A1
(43) Pub. Date: Jul. 31, 2025

(54) AEROSOL-GENERATING DEVICE WITH HOT AEROSOL EFFECT MITIGATION

(71) Applicant: Philip Morris Products S.A., Neuchatel (CH)

(72) Inventors: Matteo BOLOGNA, Lausanne (CH); Jerome UTHURRY, Neuchatel (CH)

(73) Assignee: Philip Morris Products S.A., Neuchatel (CH)

(21) Appl. No.: 18/855,712

(22) PCT Filed: May 11, 2023
(86) PCT No.: PCT/EP2023/062552

§ 371 Date: Oct. 10, 2024

(30) Foreign Application Priority Data
May 13, 2022 (EP) 22173265.4

(51) Int. Cl. A24F 40/46; A24F 40/57; A24F 40/90

(52) U.S. Cl. CPC A24F 40/46; A24F 40/57; A24F 40/90

(57) ABSTRACT

An aerosol-generating device is provided, including: a cavity to receive an aerosol-forming substrate; an electrical heater to heat the substrate within the cavity; a rechargeable power supply to provide first and second experiences without intermediate recharge therebetween; and a controller to control a supply of power to the heater, determine a rate of increase in temperature of the heater during a first time period of the first experience by determining a time taken for a temperature of the heater to increase from a first to a second predetermined temperature during the first time period, and prevent power being supplied to the heater in a second experience, if the rate of increase in temperature is below a predefined rate threshold, and if the second experience is initiated before expiry of a predefined time interval from the first experience. An aerosol-generating system, and a method of controlling the device, are also provided.

The present invention relates to an aerosol-generating device and a corresponding method for mitigating hot aerosol effect. The present invention also relates to an aerosol-generating system comprising the aerosol-generating device.

One type of aerosol-generating system is an electrically operated aerosol-generating system. Known handheld electrically operated aerosol-generating systems typically comprise an aerosol-generating device comprising a battery, control electronics and an electrical heater for heating an aerosol-generating article designed specifically for use with the aerosol-generating device. The aerosol-generating article comprises an aerosol-forming substrate. In some examples, the aerosol-forming substrate is in the form of a plug, such as a tobacco plug, and the electrical heater contained within the aerosol-generating device is inserted into the aerosol-forming substrate when the smoking article is inserted into the aerosol-generating device.

Typically, the aerosol-generating device is configured to generate heat using the electrical heater according to a predetermined heating profile. However, variations in the aerosol-forming substrate may result in undesirable variations in a user experience. For example, in high humidity environments, the aerosol-forming substrate may exhibit a high water content. Since water is aerosolised at typical operating temperatures for aerosol-generating devices, a high water content may result in an undesirably high perceived aerosol temperature (hot aerosol effect) by a user.

A high water content may also result in a lower rate of increase in temperature upon start of the user experience. Thus, this rate of increase in temperature may be used to determine whether the aerosol-forming substrate has a normal or a high water content.

New generation aerosol-generating articles may comprise an aerosol-forming substrate, which absorbs less humidity than the substrate used in conventional aerosol-generating articles. Due to the modified aerosol-forming substrate, for these aerosol-generating articles the impact of the hot aerosol effect is reduced.

However, such aerosol-generating articles may be used in aerosol-generating devices that may provide users with two or more user experiences, without intermediate recharge of the on-board power supply. Recent experiments have shown that in such aerosol generating devices, aerosol-generating articles having increased humidity have a reduced hot aerosol effect tolerance during consecutive experiences.

It would be desirable to provide an aerosol-generating device that mitigates or overcomes at least some of the disadvantages with known aerosol-generating devices.

It would be desirable to provide an aerosol-generating device that allows to mitigate the hot aerosol effect in particular in multi-experience aerosol-generating devices.

It would further be desirable to provide an aerosol-generating device that allows to select the appropriate heating profile in particular for aerosol-generating devices that provide multiple user experiences without the need for intermediate recharging.

It would further be desirable to provide an aerosol-generating device and a corresponding method that allows for improved communication with the user so as to enhance the overall user experience.

According to an embodiment of the present invention there is provided an aerosol-generating device comprising a cavity for receiving an aerosol-forming substrate, and an electrical heater arranged to heat an aerosol-forming substrate when the aerosol-forming substrate is received within the cavity, such as to provide the user an experience of inhalable aerosol. The aerosol-generating device also comprises a rechargeable power supply capable of providing at least a first experience and a second experience without intermediate recharge between the first and the second experiences, and a controller arranged to control a supply of power from the rechargeable power supply to the electrical heater.

The controller is arranged to determine a rate of increase in temperature of the electrical heater during a first time period of the first experience by determining a time taken for a temperature of the electrical heater to increase from a first predetermined temperature to a second predetermined temperature during the first time period of the first experience.

The controller is further arranged to prevent power being supplied to the heater in a second experience, if the rate of increase in temperature of the electrical heater during the first time period of the first experience is below a predefined rate threshold, and if the second experience is initiated before expiry of a predefined time interval from the first experience.

The determined rate of increase in temperature may be indicative of a water content of an aerosol-forming substrate received within the cavity. A relatively low determined rate of increase in temperature may be indicative of a relatively high water content. A relatively high determined rate of increase in temperature may be indicative of a relatively low water content. In conventional aerosol-generating devices using aerosol-forming substrates with high tobacco content, the occurrence of the hot aerosol effect was closely related to the water content of the aerosol-forming substrate.

In contrast thereto, it was observed in aerosol-generating devices, which allow for multiple user experiences, that also other factors play an important role in the formation and occurrence of the hot aerosol effect. In particular if an aerosol-forming substrate with reduced tobacco content is used, the occurrence of the hot aerosol effect was generally reduced. However, it was observed that for aerosol-forming substrates with a high water content the hot aerosol effect occurred primarily during a consecutive user experience, in particular, if the consecutive user experience was taken shortly after a previous user experience.

Accordingly, the present invention aims at mitigating the hot aerosol-effect by forcing a time delay between user experiences, in case an aerosol-forming substrate with high water content is detected. For this purpose, in a first time period of a first user experience, the rate of increase in temperature of the electrical heater is determined. If the determined rate is below a predefined rate threshold, the aerosol-forming substrate is considered to have a high water content. The controller is configured to force a time delay between consecutive user experiences, if an aerosol-forming substrate with high water content is used. The consecutive user experience may then only be initiated after the expiry of a predefined time interval from the previous experience.

The present invention is directed to aerosol-generating devices allowing for at least two consecutive user experiences without the need for intermediate recharge of the power source. The aerosol-generating devices may allow for up to 20 or even more consecutive user experiences without the need for intermediate recharge.

The invention is particularly useful for aerosol devices which allow for two or more user experiences without intermediate recharge. Therefore, in the invention is generally described referring to a “first experience” and a “second experience”. However, the invention is not limited to first and second experiences, but may be generally useful for controlling any two consecutive user experiences.

Accordingly it is to be understood that the terms “first experience” or “previous experience” are used synonymously to denote a first of two consecutive user experiences.

In the same way, the terms “second experience” or “consecutive experience” are used synonymously to denote a second of two consecutive user experiences.

Preferably, the first time period of the first experience is sufficiently long to ensure a measurable increase in the temperature of the electrical heater across a range of water contents for the aerosol-forming substrate. Preferably, the first time period is at least about 1 second, more preferably at least about 2 seconds, more preferably at least about 3 seconds.

Preferably, the first time period of the first experience is sufficiently short to minimise the time before the controller varies the supply of power to the electrical heater during the second time period to provide a desired user experience. Preferably, the first time period is less than about 15 seconds, more preferably less than about 14 seconds, more preferably less than about 13 seconds, more preferably less than about 12 seconds, more preferably less than about 11 seconds, more preferably less than about 10 seconds.

The controller may be arranged to determine a rate of increase in temperature of the electrical heater by determining the time taken for a predetermined increase in temperature of the electrical heater to occur. The controller may be arranged to determine a rate of increase in temperature of the electrical heater during a portion of the first time period. The controller may be arranged to determine a time taken for a temperature of the electrical heater to increase from a first predetermined temperature to a second predetermined temperature during the first time period, wherein the determined time is the determined rate of increase in temperature.

Preferably, the first predetermined temperature is above any anticipated ambient temperature. Advantageously, a first predetermined temperature above ambient temperature may minimise or eliminate any variation in ambient temperature on the determined rate of increase in temperature of the electrical heater. Preferably, the first predetermined temperature is at least about 50 degrees Celsius, preferably at least about 60 degrees Celsius, preferably at least about 70 degrees Celsius, preferably at least about 80 degrees Celsius, preferably at least about 90 degrees Celsius. The first predetermined temperature may be 100 degrees Celsius. The first predetermined temperature may at least be about 150 degrees Celsius. The first predetermined temperature may at least be about 200 degrees Celsius.

It is understood that numerical values specified herein encompass a range of values around the specified value based on variations resulting from manufacturing tolerances and accuracy of measuring instruments.

Preferably, the second predetermined temperature is below a target operating temperature of the electrical heater during the second period of time. Advantageously, a second predetermined temperature below a target operating temperature may facilitate determination of the rate of increase in temperature of the electrical heater before the controller is required to begin adjusting the supply of power to the electrical heater during the second time period. Preferably, the second predetermined temperature is less than about 400 degrees Celsius, preferably less than about 320 degrees Celsius, preferably less than about 290 degrees Celsius, preferably less than about 280 degrees Celsius, preferably less than about 270 degrees Celsius, preferably less than about 260 degrees Celsius. The second predetermined temperature may be 250 degrees Celsius.

Preferably, the controller is arranged to supply power from the power supply to the electrical heater at a constant rate for the first time period of the first experience. Advantageously, supplying power to the electrical heater at a constant rate for the first time period may facilitate an accurate determination of the rate of increase in temperature of the electrical heater during the first time period. The controller may be arranged to supply power from the power supply to the electrical heater at any desired duty cycle during the first time period. The controller may be arranged to supply power from the power supply to the electrical heater at a duty cycle of at least about 50 percent during the first time period. The controller may be arranged to supply power from the power supply to the electrical heater at a duty cycle of at least about 85 percent during the first time period. The controller may be arranged to supply power from the power supply to the electrical heater at a duty cycle of at least about 90 percent during the first time period. The controller may be arranged to supply power from the power supply to the electrical heater at a duty cycle of at least about 95 percent during the first time period.

The controller may be arranged to evaluate the rate of increase in temperature of the heater element in a first period of a first experience at any time during use of the aerosol-generating device.

The controller may be arranged to evaluate the rate of increase in temperature of the heater element of a first experience when the user is initiating the second experience. At this moment in time, the controller may determine the increase in temperature of the heater element of a first experience and may at the same time determine the elapsed time since the first experience. If the controller determines that the determined temperature increase rate was below a predetermined threshold and that the elapsed time after the first experience is below a predefined time interval, activation of the electrical heater to carry out the second experience is prevented.

The predefined time interval may range from 100 to 300 seconds. The predefined time interval may range from 120 to 280 seconds. The predefined time interval may range from 150 to 200 seconds. The predefined time interval may amount to about 180 seconds.

On the other hand, if the controller determines that the determined rate was above a predetermined threshold or the elapsed time after the first experience is above the predefined time interval, activation of the heater is enabled and the user is allowed to perform a second user experience.

Advantageously, the controller may be arranged to first determine the elapsed time between the two consecutive user experiences. If the elapsed time is above the predefined time interval, the second experience may in any case be carried out. Thus, in this situation an evaluation of the rate of increase in temperature of the heater element in the first experience is not necessary anymore. In this way, complexity of the controller scheme can be reduced and less controller operations are required.

However, the above described procedure may be perceived as inconvenient, since the information that a further user experience is momentarily not available is delivered by the aerosol-generating device only after the user has already decided to initiate the next user experience. Thus, it may be more convenient for a user to be informed about the availability of the next user experience, already in advance and preferably already at the end of the first user experience. In this way a user may for example be informed on availability or non-availability of the next user experience, already before the user may insert a new aerosol-generating article into the aerosol-generating device.

The controller of the aerosol-generating device may therefore be arranged to determine the rate of increase in temperature of the electrical heater at the end of the first experience. If the controller determines that the determined rate of increase in temperature of the electrical heater was above a predetermined threshold rate, there is no need to force a time delay before the next user experience is delivered. The aerosol may indicate to the user by any suitable means that a consecutive experience is available.

If the controller determines that the determined rate was below a predetermined threshold, activation of the electrical heater to carry out the second experience is prevented and the second user experience may then only be initiated after the expiry of the predefined time interval from the first experience.

In order to inform the user of the need to have a time-out before the next user experience can be started, the controller may be configured to alert the user thereof via a suitable user interface. By informing the user of the required time delay before the next user experience can be started, the user can already adopt oneself to the required waiting time. This may help to increase usability of the aerosol-generating device for the user.

The user interface may include means to indicate to the user the duration of the required time-out period. The user interface may include acoustic, visual, haptic, sensorial or any other suitable means.

Visual user interface means may include a suitable light source. Advantageously light source with low power consumption may be used. Such suitable light sources include light emitting diodes (LED), micro LEDs or organic LEDs (OLED) devices. These light sources may be operated in a flashing mode to attract the user's attention. For example, a red LED may be operated in flashing mode throughout the time-out period, in order to inform the user that the aerosol-generating device is not yet ready for operation. Once the time-out period has expired, flashing of the LED may be stopped. This may inform the user that the aerosol-generating device is ready for the next experience.

The controller may comprise an electrical storage element. The controller may be arranged to communicate with the electrical storage element. The controller may be arranged to write to and read from the electrical storage element parameters or other information pertaining to the control of the aerosol-generating device. The controller may be arranged to store the rate of increase of the electrical heater determined in the last user experience. The controller may be arranged to store a lastly used heating profile in the electrical storage element. The electrical storage element may be a memory element.

The controller may be arranged to determine the initial temperature of the electrical heater and may be further arranged to prevent power from being supplied to the electrical heater, if the initial temperature of the electrical heater is above a predefined temperature threshold. Usually, if the controller requires a mandatory time out between two user experiences, the electrical heater should have sufficiently time to cool down. In this situation the electrical heater will most likely have an initial temperature that is well below the predefined temperature threshold.

However, if the determined rate of increase of the temperature of the electrical heater during a first experience was above a predetermined threshold rate, and the controller does not require a time delay before the next user experience, the initial temperature of the electrical heater may be increased and may be above the predefined temperature threshold at the beginning of the consecutive experience. If the controller determines the initial temperature of the electrical heater to be above the predefined temperature threshold, power may be prevented from being supplied to the electrical heater. The controller may be configured to monitor the temperature of the electrical heater in regular intervals.

The controller may be further arranged to start supplying power from the power supply to the electrical heater, once the initial temperature of the electrical heater has dropped below the predefined temperature threshold.

The predefined temperature threshold for the initial temperature of the electrical heater may be between about 50 degrees Celsius and about 150 degrees Celsius, between about 60 degrees Celsius and about 120 degrees Celsius or preferably between about 80 degrees Celsius and about 100 degrees Celsius. The predefined temperature threshold for the initial temperature of the electrical heater may be 80 degrees Celsius.

To facilitate determining the rate of increase in temperature of the electrical heater, preferably the controller is arranged to determine a temperature of the electrical heater. Preferably, the electrical heater comprises at least one resistive heating element, wherein the controller is arranged to determine a temperature of the at least one resistive heating element based on a resistance of the at least one resistive heating element. The controller may comprise a circuit arranged to measure a resistance of the at least one resistive heating element. The controller may be arranged to determine a temperature of the at least one resistive heating element by comparing the measured resistance to a calibrated curve of resistance against temperature.

Preferably, the electrical heater comprises a plurality of resistive heating elements. Preferably, the resistive heating elements are electrically connected in a parallel arrangement. Advantageously, providing a plurality of resistive heating element electrically connected in a parallel arrangement may facilitate the delivery of a desired electrical power to the electrical heater while reducing or minimising the voltage required to provide the desired electrical power. Advantageously, reducing or minimising the voltage required to operate the electrical heater may facilitate reducing or minimising the physical size of the power supply.

The electrical heater may comprise an electrically insulating substrate, wherein the at least one resistive heating element is provided on the electrically insulating substrate.

Preferably, the electrically insulating substrate is stable at an operating temperature of the electrical heater. Preferably, the electrically insulating substrate is stable at temperatures of up to about 400 degrees Celsius, more preferably about 500 degrees Celsius, more preferably about 600 degrees Celsius, more preferably about 700 degrees Celsius, more preferably about 800 degrees Celsius. The operating temperature of the electrical heater during use may be at least about 200 degrees Celsius. The operating temperature of the electrical heater during use may be less than about 700 degrees Celsius. The operating temperature of the electrical heater during use may be less than about 600 degrees Celsius. The operating temperature of the electrical heater during use may be less than about 500 degrees Celsius. The operating temperature of the electrical heater during use may be less than about 400 degrees Celsius.

The electrically insulating substrate may be a ceramic material such as Zirconia or Alumina. Preferably, the electrically insulating substrate has a thermal conductivity of less than or equal to about 2 Watts per metre Kelvin.

Suitable materials for forming the at least one resistive heating element include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-and iron-containing alloys, and super-alloys based on nickel, iron, cobalt, stainless steel, Timetai® and iron-manganese-aluminium based alloys.

In some embodiments, the at least one resistive heating element comprises one or more stamped portions of electrically resistive material, such as stainless steel. Alternatively, the at least one resistive heating element may comprise a heating wire or filament, for example a Ni—Cr (Nickel-Chromium), platinum, tungsten or alloy wire.

The electrical heater may be arranged for insertion into an aerosol-forming substrate when the aerosol-forming substrate is received within the cavity. The electrical heater may be positioned within the cavity. The electrical heater may be an elongate electrical heater. The elongate electrical heater may be blade-shaped. The elongate electrical heater may be pinshaped. The elongate electrical heater may be cone-shaped. The elongate electrical heater may be blade-shaped.

The controller may be arranged to supply power from the power supply to the electrical heater according to a first heating profile or to a second heating profile during the second time period of each user experience.

The controller may be arranged to supply power from the power supply to the electrical heater according to a first heating profile or to a second heating profile during the second time period of each user experience, based on a comparison of the determined rate of increase in temperature of the electrical heater in the first time period of an experience with a predefined rate threshold.

As discussed above, if the aerosol-forming substrate has a relatively low water content, the determined rate of increase in temperature of the electrical heater in the first time period of an experience may be above a predefined rate threshold. The controller may be arranged to supply power from the power supply to the electrical heater according to a first heating profile, if the determined rate of increase in temperature of the electrical heater in the first time period of an experience is above the predefined rate threshold. The first heating profile may also be referred to as a “standard heating profile”.

As also discussed above, if the aerosol-forming substrate has a relatively high water content, the determined rate of increase in temperature of the electrical heater in the first time period of an experience may be below a predefined rate threshold. The controller may be arranged to supply power from the power supply to the electrical heater according to a second heating profile, if the determined rate of increase in temperature of the electrical heater in the first time period of an experience is below the predefined rate threshold. Therefore, the second heating profile may also be referred to as a “wet heating profile”.

The two heating profiles may differ with respect to the total electrical power delivered during an experience. The two heating profiles may differ with respect to the duty cycle or the duty cycles applied during an experience. The two heating profiles may differ with respect to the targeted operation temperatures during an experience.

In embodiments in which the controller determines a rate of increase in temperature of the electrical heater by determining the time taken for a predetermined increase in temperature of the electrical heater to occur, the first threshold may be a time threshold. The controller is arranged to supply power to the electrical heater according to a first heating profile when the determined time is below the first time threshold. The controller is arranged to supply power to the electrical heater according to a second heating profile when the determined time is above the first time threshold. The first time threshold may be a time of between about 3 seconds and about 10 seconds. The first threshold may be a time of between about 5 seconds and about 7 seconds. The first threshold may be a time of 5.7seconds.

Preferably, the controller is arranged to determine an ambient temperature.

Preferably, the controller is arranged to supply power from the power supply to the electrical heater according to the first heating profile when the determined ambient temperature is below the ambient temperature threshold.

The present inventors have recognised that the rate of increase in temperature of an aerosol-forming substrate having a normal water content may be significantly lower when the ambient temperature is low. In other words, in a cold environment, the determined rate of increase in temperature of the electrical heater when used with an aerosol-forming substrate having a normal water content may be similar to the determined rate of increase in temperature of the electrical heater when used with an aerosol-forming substrate having a high water content at a normal ambient temperature.

The present inventors have recognised that, when the ambient temperature is low, it is not necessary to supply power to the electrical heater according to the second heating profile for aerosol-forming substrate having a high water content. In particular, advantageously, the cool ambient air entering the aerosol-generating device during use is sufficient to maintain the temperature of the generated aerosol at a level acceptable to a user, even when the aerosol-forming substrate has a high water content. Preferably, the ambient temperature threshold is between about 15 degrees Celsius and about 25 degrees

Celsius, preferably between about 17 degrees Celsius and about 23 degrees Celsius. The ambient temperature threshold may be 18 degrees Celsius.

The aerosol-generating device may comprise a temperature sensor arranged to sense the ambient temperature, wherein the controller is arranged to determine the ambient temperature based on a signal received from the temperature sensor. The temperature sensor may comprise a thermistor. The temperature sensor may comprise a thermocouple. The temperature sensor may comprise a semiconductor temperature sensor.

According to an embodiment of the present invention there is provided an aerosol-generating system comprising an aerosol-generating device according to the present invention, in accordance with any of the embodiments described herein, and an aerosol-generating article comprising an aerosol-forming substrate.

As used herein, the term “aerosol-generating article” refers to an article comprising an aerosol-forming substrate that, when heated, releases volatile compounds that can form an aerosol.

The aerosol-forming substrate may comprise tobacco.

The aerosol-forming substrate may comprise a plug of tobacco. The tobacco plug may comprise one or more of: powder, granules, pellets, shreds, spaghettis, strips or sheets containing one or more of: tobacco leaf, fragments of tobacco ribs, reconstituted tobacco, homogenised tobacco, extruded tobacco and expanded tobacco. Optionally, the tobacco plug may contain additional tobacco or non-tobacco volatile flavour compounds, to be released upon heating of the tobacco plug. Optionally, the tobacco plug may also contain capsules that, for example, include the additional tobacco or non-tobacco volatile flavour compounds. Such capsules may melt during heating of the tobacco plug. Alternatively, or in addition, such capsules may be crushed prior to, during, or after heating of the tobacco plug.

Where the tobacco plug comprises homogenised tobacco material, the homogenised tobacco material may be formed by agglomerating particulate tobacco. The homogenised tobacco material may be in the form of a sheet. The homogenised tobacco material may have an aerosol-former content of greater than 5 percent on a dry weight basis. The homogenised tobacco material may alternatively have an aerosol former content of between 5 percent and 30 percent by weight on a dry weight basis. Sheets of homogenised tobacco material may be formed by agglomerating particulate tobacco obtained by grinding or otherwise comminuting one or both of tobacco leaf lamina and tobacco leaf stems; alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco. Alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof. Sheets of homogenised tobacco material are preferably formed by a casting process of the type generally comprising casting a slurry comprising particulate tobacco and one or more binders onto a conveyor belt or other support surface, drying the cast slurry to form a sheet of homogenised tobacco material and removing the sheet of homogenised tobacco material from the support surface.

The aerosol-generating article may have a total length of between approximately 30 millimetres and approximately 100 millimetres. The aerosol-generating article may have an external diameter of between approximately 5 millimetres and approximately 13 millimetres.

The aerosol-generating article may comprise a mouthpiece positioned downstream of the tobacco plug. The mouthpiece may be located at a downstream end of the aerosol-generating article. The mouthpiece may be a cellulose acetate filter plug. Preferably, the mouthpiece is approximately 7 millimetres in length, but can have a length of between approximately 5 millimetres to approximately 10 millimetres.

The tobacco plug may have a length of approximately 10 millimetres. The tobacco plug may have a length of approximately 12 millimetres.

The diameter of the tobacco plug may be between approximately 5 millimetres and approximately 12 millimetres.

In a preferred embodiment, the aerosol-generating article has a total length of between approximately 40 millimetres and approximately 50 millimetres. Preferably, the aerosol-generating article has a total length of approximately 45 millimetres. Preferably, the aerosol-generating article has an external diameter of approximately 7.2 millimetres.

According to an embodiment of the present invention, there is provided a method of controlling an aerosol-generating device having a cavity for receiving an aerosol-forming substrate, a rechargeable power supply capable of providing at least a first experience and a second experience without intermediate recharge between the first and the second experiences, and an electrical heater arranged to heat an aerosol-forming substrate when the aerosol-forming substrate is received within the cavity. The method comprises a step of controlling a supply of power from the power supply to the electrical heater. The method also comprises a step of determining a rate of increase in temperature of the electrical heater during the first time period of the first experience by determining a time taken for a temperature of the electrical heater to increase from a first predetermined temperature to a second predetermined temperature during the first time period of the first experience. The method further comprising the step of preventing power being supplied to the heater in a second experience, if the rate of increase in temperature of the electrical heater during the first time period of the first experience is below a predefined rate threshold, and if the second experience is initiated before expiry of a predefined time interval from the first experience.

The controller may evaluate the rate of increase in temperature of the heater element in a first period of a first experience at any time during use of the aerosol-generating device. The

The controller may evaluate the rate of increase in temperature of the heater element of a first experience when the user is initiating the second experience. At this moment in time, the controller may determine the increase in temperature of the heater element of a first experience and may at the same time determine the elapsed time since the first experience. If the controller determines that the determined temperature increase rate was below a predetermined threshold and that the elapsed time after the first experience is below a predefined time interval, activation of the electrical heater to carry out the second experience is prevented.

The predefined time interval may range from 100 to 300 seconds. The predefined time interval may range from 120 to 280 seconds. The predefined time interval may range from 150 to 200 seconds. The predefined time interval may amount to about 180 seconds.

On the other hand, if the controller determines that the determined rate was above a predetermined threshold or the elapsed time after the first experience is above the predefined time interval, activation of the heater is enabled and the user is allowed to perform a second user experience.

Advantageously, the controller may first determine the elapsed time between the two consecutive user experiences. If the elapsed time is above the predefined time interval, the second experience may in any case be carried out. Thus, in this situation an evaluation of the rate of increase in temperature of the heater element in the first experience is not necessary anymore. In this way, complexity of the controller scheme can be reduced and less controller operations are required.

The controller of the aerosol-generating device may evaluate the rate of increase in temperature of the electrical heater at the end of the first experience. If the controller determines that the determined rate of increase in temperature of the electrical heater was above a predetermined threshold rate, there is no need to force a time delay before the next user experience is delivered. The controller may indicate to the user by any suitable means that a consecutive experience is available. This may be done via a visual user interface such as a flashing green LED.

If the controller determines that the rate of increase in temperature of the electrical heater was below a predetermined threshold, activation of the electrical heater to carry out the second experience is prevented and the second user experience may then only be initiated after the expiry of the predefined time interval from the first experience.

In order to inform the user of the need to have a time-out before the next user experience can be started, the controller may alert the user thereof via a suitable user interface. By informing the user of the required time delay before the next user experience can be started, the user can already adopt oneself to the required waiting time. This may help to increase usability of the aerosol-generating device for the user.

The user interface may include means to indicate to the user the duration of the required time-out period. The user interface may include acoustic, visual, haptic, sensorial or any other suitable means.

Visual user interface means may include a suitable light source. Advantageously light source with low power consumption may be used. Such suitable light sources include light emitting diodes (LED), micro LEDs or organic LEDs (OLED) devices. These light sources may be operated in a flashing mode to attract the user's attention. For example, a red LED may be operated in flashing mode throughout the time-out period, in order to inform the user that the aerosol-generating device is not yet ready for operation. Once the time-out period has expired, flashing of the LED may be stopped. This may inform the user that the aerosol-generating device is ready for the next experience.

Below, there is provided a non-exhaustive list of non-limiting examples. Any one or more of the features of these examples may be combined with any one or more features of another example, embodiment, or aspect described herein.

Example A: An aerosol-generating device comprising:

a cavity for receiving an aerosol-forming substrate;

an electrical heater arranged to heat an aerosol-forming substrate when the aerosol-forming substrate is received within the cavity, such as to provide the user an experience of inhalable aerosol;

a rechargeable power supply capable of providing at least a first experience and a second experience without intermediate recharge between the first and the second experiences; and

a controller arranged to control a supply of power from the rechargeable power supply to the electrical heater;

wherein the controller is arranged to determine a rate of increase in temperature of the electrical heater during a first time period of the first experience by determining a time taken for a temperature of the electrical heater to increase from a first predetermined temperature to a second predetermined temperature during the first time period of the first experience, and

wherein the controller is further arranged to prevent power being supplied to the heater in a second experience, if the rate of increase in temperature of the electrical heater during the first time period of the first experience is below a predefined rate threshold, and if the second experience is initiated before expiry of a predefined time interval from the first experience.

Example B: An aerosol-generating device according to example A, wherein the controller comprises an electrical storage element, and wherein the controller is arranged to store the rate of increase in temperature determined during the last experience.

Example C: An aerosol-generating device according to examples A or B, wherein the controller is arranged to check the rate of increase in temperature and the elapsed time interval between the first experience and the second experience when the user is initiating the second experience.

Example D: An aerosol-generating device according to examples A or B, wherein the controller is arranged to check the rate of increase in temperature at the end of the first experience.

Example E: An aerosol-generating device according to example D, wherein, if the controller determines that the rate of increase in temperature was below a predefined threshold, the user is alerted of a required time-out via a user interface.

Example F: An aerosol-generating device according to example E, wherein the user alert includes indicating to the user the duration of the time-out.

Example G: An aerosol-generating device according to example E or F, wherein the user alert includes visually indicating via an optical element throughout the time-out interval that the device is not ready for the second experience.

Example H: An aerosol-generating device according to any preceding example, wherein the controller is arranged to determine an initial temperature of the electrical heater, and wherein the controller is further arranged to supply power from the power supply to the electrical heater if the initial temperature of the electrical heater is below a predefined temperature threshold.

Example I: An aerosol-generating device according to example H, wherein the controller is arranged to determine the initial temperature of the electrical heater and wherein the controller is further arranged to prevent power being supplied to the heater, if the initial temperature of the electrical heater is above a predefined temperature threshold.

Example J: An aerosol-generating device according to example H or I, wherein the temperature threshold is in a range from 60 degrees Celsius to 120 degrees Celsius, wherein the temperature threshold is in a range from 80 degrees Celsius to 100 degrees Celsius, or wherein the temperature threshold is about 80 degrees Celsius.

Example K: An aerosol-generating device according to any one of examples H to J, wherein the electrical heater comprises a resistive heating element, wherein the controller is arranged to determine a temperature of the resistive heating element based on a resistance of the resistive heating element.

Example L: An aerosol-generating device according to any preceding example, wherein the controller is arranged to supply power from the power supply to the electrical heater at a constant rate for the first time period of the first experience.

Example M: An aerosol-generating device according to any preceding example, wherein the controller is arranged to supply power from the power supply to the electrical heater according to a first heating profile during a second time period of each experience.

Example N: An aerosol-generating device according to any preceding example, wherein the controller is arranged to adjust the supply of power from the power supply to the electrical heater based on the determined rate of increase in temperature of the electrical heater during the first time period of the first experience.

Example O: An aerosol-generating device according to any preceding example, wherein the controller is arranged to supply power from the power supply to the electrical heater according to a second heating profile during a second time period of an experience, when the determined rate of increase in temperature of the electrical heater during the first time period of the experience is below the predetermined threshold.

Example P: An aerosol-generating device according to any preceding example, wherein the controller is arranged to determine an ambient temperature, wherein the controller is arranged to supply power from the power supply to the electrical heater according to the first heating profile when the determined ambient temperature is below the ambient temperature threshold.

Example Q: An aerosol-generating device according to example P, further comprising a temperature sensor arranged to sense the ambient temperature, wherein the controller is arranged to determine the ambient temperature based on a signal received from the temperature sensor.

Example R: An aerosol-generating system comprising:

an aerosol-generating device according to any preceding example; and

an aerosol-generating article comprising an aerosol-forming substrate.

Example S: An aerosol-generating system according to example R, wherein the aerosol-forming substrate comprises tobacco.

Example T: A method of controlling an aerosol-generating device having a cavity for receiving an aerosol-forming substrate, a rechargeable power supply, and an electrical heater arranged to heat an aerosol-forming substrate when the aerosol-forming substrate is received within the cavity, such as to provide the user an experience of inhalable aerosol;

wherein the rechargeable power supply is capable of providing at least a first experience and a second experience without intermediate recharge between the first and the second experiences;

the method comprising the steps of:

controlling a supply of power from the power supply to the electrical heater;

determining a rate of increase in temperature of the electrical heater during a first time period of the first experience by determining a time taken for a temperature of the electrical heater to increase from a first predetermined temperature to a second predetermined temperature during the first time period of the first experience, and

preventing power being supplied to the heater in a second experience, if the rate of increase in temperature of the electrical heater during the first time period of the first experience is below a predefined rate threshold, and if the second experience is initiated before expiry of a predefined time interval from the first experience.

Example U: A method according to example T, wherein the controller is arranged to check the rate of increase in temperature and the elapsed time interval between the first experience and the second experience when the user is initiating the second experience.

Example V: A method according to example T, wherein the controller is arranged to check the rate of increase in temperature at the end of the first experience.

Example W: A method according to example V, wherein, if the controller determines that the rate of increase in temperature was below a predefined threshold, the user is alerted of a required time-out via a user interface.

Example X: A method according to example W, wherein the user alert includes indicating to the user the duration of the time-out.

Example Y: A method according to example W or X, wherein the user alert includes visually indicating via an optical element throughout the time-out interval that the device is not ready for the second experience.

Example Z: A method according to any of examples T to Y, wherein the time-out interval is between 60 and 420 seconds, wherein the time-out interval is between 120 and 360 seconds, wherein the time-out interval is between 150 and 210 seconds, and wherein the time-out interval is about 180 seconds.

Example ZA: A method according to any of examples T to Z, wherein the controller determines an initial temperature of the electrical heater, and wherein the controller supplies power from the power supply to the electrical heater if the initial temperature of the electrical heater is below a predefined temperature threshold.

Example ZB: A method according to any of examples T to ZA, wherein the controller determines the initial temperature of the electrical heater and wherein the controller prevents power being supplied to the heater, if the initial temperature of the electrical heater is above a predefined temperature threshold.

Example ZC: A method according to example ZA or ZB, wherein the temperature threshold is in a range from 60 degrees Celsius to 120 degrees Celsius, wherein the temperature threshold is in a range from 80 degrees Celsius to 100 degrees Celsius, or wherein the temperature threshold is about 80 degrees Celsius.

Example ZD: A method according to any of examples ZA to ZC, wherein the electrical heater comprises a resistive heating element, wherein the controller is arranged to determine a temperature of the resistive heating element based on a resistance of the resistive heating element.

Example ZE: A method according to any of examples T to ZD, wherein the step of controlling a supply of power from the power supply to the electrical heater for a first time period comprises supplying power from the power supply to the electrical heater at a constant rate for the first time period.

Example ZF: A method according to any of examples T to ZE, wherein the controller supplies power from the power supply to the electrical heater according to a first heating profile during second time period of each experience.

Example ZG: A method according to any of examples T to ZF, wherein the controller adjusts the supply of power from the power supply to the electrical heater based on the determined rate of increase in temperature of the electrical heater during the first time period of the first experience.

Example ZH: A method according to any of examples T to ZG, wherein the controller supplies power from the power supply to the electrical heater according to a second heating profile during a second time period of the second experience, when the determined rate of increase in temperature of the electrical heater during the first time period of the first experience, is below a predetermined threshold.

Example ZI: A method according to any of examples T to ZH, wherein the controller determines an ambient temperature, wherein the controller supplies power from the power supply to the electrical heater according to the first heating profile when the determined ambient temperature is below the ambient temperature threshold.

Example ZJ: A method according to example ZI, further comprising a temperature sensor arranged to sense the ambient temperature, wherein the controller determines the ambient temperature based on a signal received from the temperature sensor.

Example ZK: A computer program that, when executed on a computer or other processing device, carries out the method of examples T to ZK.

Features described in relation to one embodiment may equally be applied to other embodiments of the invention.

The invention will be further described, by way of example only, with reference to the accompanying drawings in which:

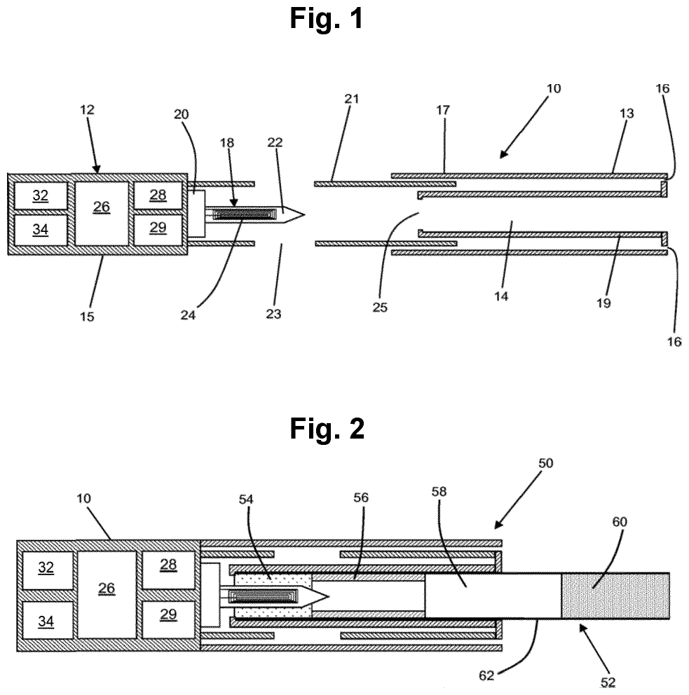

FIG. 1 shows a cross-sectional view of an aerosol-generating device according to an embodiment of the present invention;

FIG. 2 shows a cross-sectional view of an aerosol-generating system comprising the aerosol-generating device of FIG. 1;

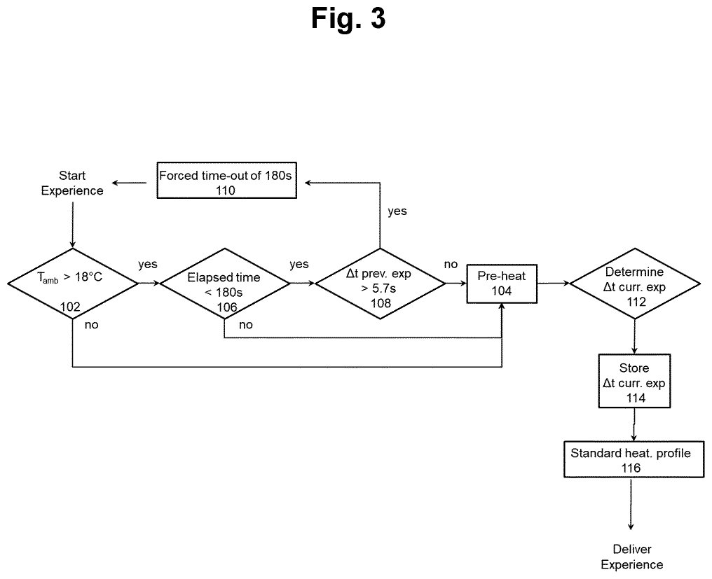

FIG. 3 illustrates a method carried out by the controller of the aerosol-generating device of FIG. 1;

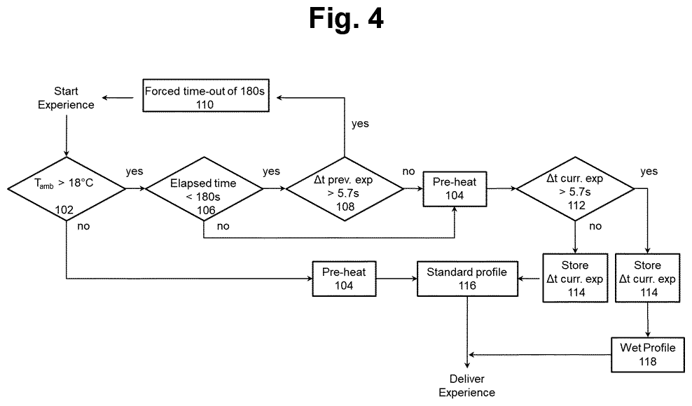

FIG. 4 illustrates a modification of the method of FIG. 3 including delivery of different heating profiles;

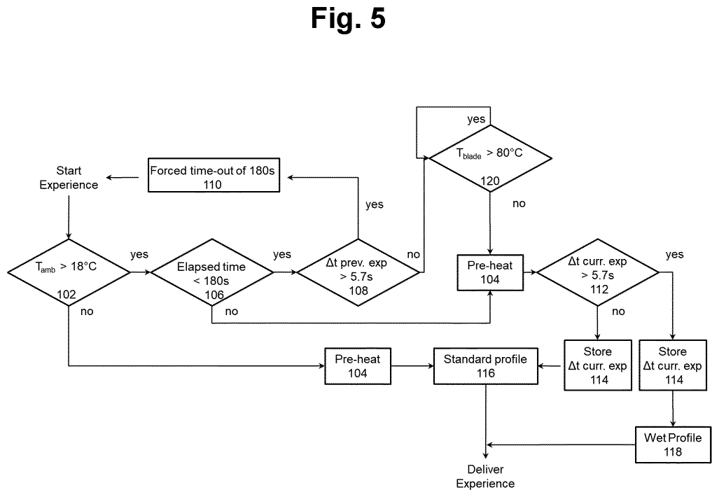

FIG. 5 illustrates a modification of the method of FIG. 4 including a temperature check of the electric heater;

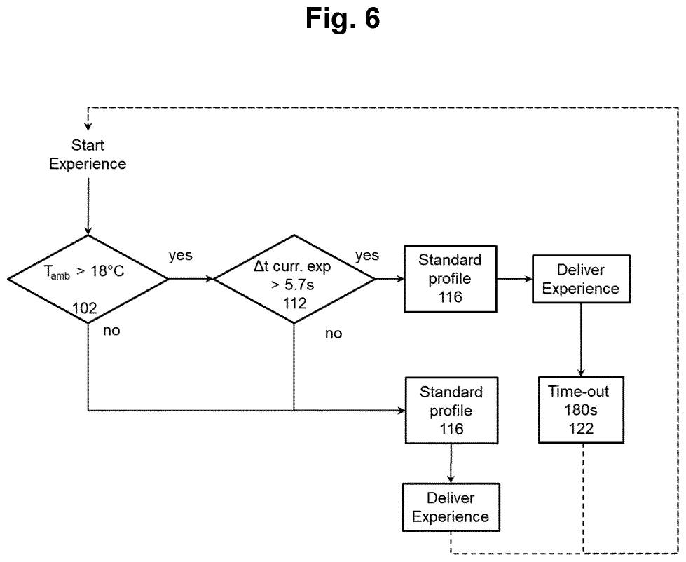

FIG. 6 illustrates a method in which a time-out is forced at the end of a first user experience;

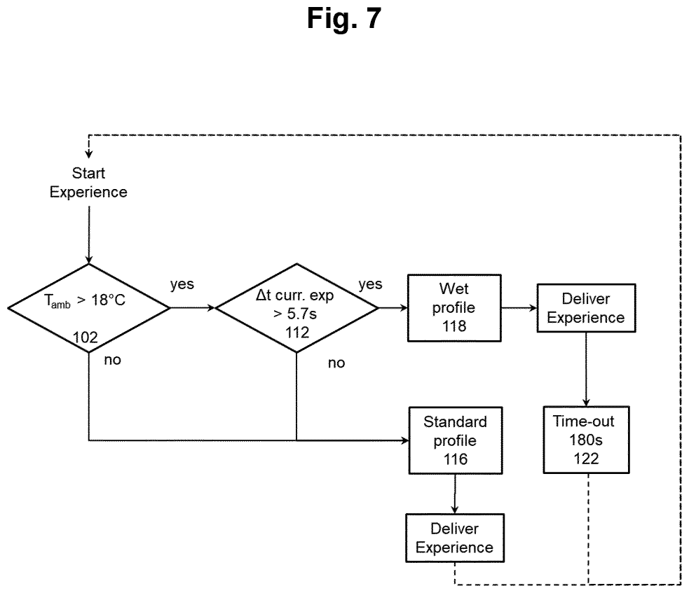

FIG. 7 illustrates a modification of the method of FIG. 6 including delivery of different heating profiles; and

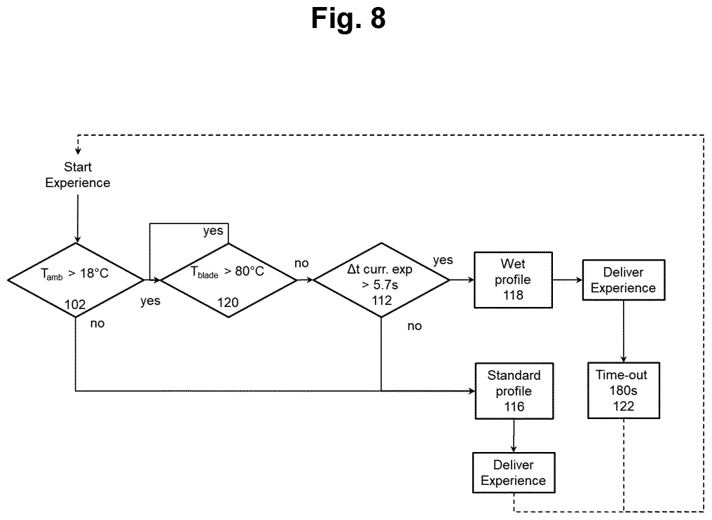

FIG. 8 illustrates a modification of the method of FIG. 7 including a temperature check of the electric heater.

FIG. 1 shows a cross-sectional view of an aerosol-generating device 10 according to an embodiment of the present invention. The aerosol-generating device 10 comprises a generally cylindrical housing 12 comprising a front housing portion 13 and a rear housing portion 15. The front housing portion 13 is slidably removable from the rear housing portion 15 and is illustrated in a partially removed position in FIG. 1.

The front housing portion 13 comprises an outer wall 17 and an inner wall 19, wherein the inner wall 19 defines a cavity 14 for receiving an aerosol-forming substrate. A plurality of air inlets 16 for admitting air into the aerosol-generating device 12 are defined between the outer wall 17 and the inner wall 19 at an end of the front housing portion 13.

The rear housing portion 15 comprises a cylindrical wall 21 that is received between the outer wall 17 and the inner wall 19 of the front housing portion 13 when the front housing portion 13 is received on the rear housing portion 15. The cylindrical wall 21 defines a plurality of elongate slots 23.

The aerosol-generating device 10 also comprises an electrical heater 18 positioned on the rear housing portion 15 and arranged to extend through an aperture 25 defined by the inner wall 19 and into the cavity 14 when the front housing portion 13 is received on the rear housing portion 15. During use, air flows into the aerosol-generating device 10 through the air inlets 16, through the slots 23 defined by the cylindrical wall 21, and through the aperture 25 into the cavity 14.

The electrical heater 18 comprises a base portion 20 and an elongate electrically insulating substrate 22 extending from the base portion 20. The elongate electrically insulating substrate 22 is formed from a ceramic material. The elongate electrically insulating substrate 22 is blade shaped to facilitate insertion of the elongate electrically insulating substrate 22 into an aerosol-forming substrate when the aerosol-forming substrate is received within the cavity 14.

The electrical heater 18 also comprises a plurality of resistive heating elements 24 positioned on the elongate electrically insulating substrate 22.

The aerosol-generating device 10 also comprises a power supply 26, a controller 28 and a temperature sensor 29. The controller 28 may be arranged to perform several functions including controlling the supply of power from the power supply 26 to the resistive heating element 24 of the electrical heater 18. The power supply 26 comprises a rechargeable battery.

The aerosol-generating device 10 further comprises a storage element 32 and a user interface 34. The controller 28 is arranged to write to and read from the storage element 32. In particular the controller 28 is arranged to store the rate of increase of the electrical heater 18 determined in the last user experience in the storage element 32. In this embodiment the user interface 34 is a LED. The controller 28 is configured to inform the user via the user interface 34 of the current status of the aerosol-generating device 10.

FIG. 2 shows a cross-sectional view of an aerosol-generating system 50 comprising the aerosol-generating device 10 of FIG. 1 and an aerosol-generating article 52 received within the cavity 14 of the aerosol-generating device 10. The aerosol-generating device 10 is illustrated in FIG. 2 with the front housing portion 13 fully received on the rear housing portion 15.

The aerosol-generating article 52 comprises an aerosol-forming substrate 54 in the form of a tobacco plug, a hollow acetate tube 56, a polymeric filter 58, a mouthpiece 60 and an outer wrapper 62. When the aerosol-generating article 52 is received within the cavity 14 of the aerosol-generating device 10, the elongate electrically insulating substrate 22 and the resistive heating element 24 of the electrical heater 18 are received within the tobacco plug.

The controller 28 of the aerosol-generating device 10 is arranged to carry out the method 100 illustrated in FIG. 3 when the aerosol-generating article 52 is inserted into the cavity 14 and the aerosol-generating device 10 is switched on by a user.

Upon initiation of the device, the experience is started. In a step 102, the controller 28 determines an ambient temperature using the temperature sensor 29. If the ambient temperature is below 18 degrees Celsius, electrical power is supplied from the power supply 26 to the electrical heater 18 for pre-heating the electrical heater 18 in a step 104.

For generation of an aerosol and for delivering the experience to the user, electrical power is supplied from the power supply 26 to the electrical heater 18 according to a first heating profile (step 116). For this purpose, the controller 28 is arranged to supply energy to the electrical heater 18 in two consecutive time periods. During a first time period of the current user experience, the controller 28 is arranged to supply power from the power supply 26 to the electrical heater 18 at a constant rate. The controller 28 is arranged to determine the rate of increase in temperature of the electrical heater 18 during this first time period. For this purpose the controller 28 is arranged for determining (step 112) and storing (step 114) during the first time period of user experience the time required for the electrical heater 18 to be heated from the first predefined temperature of 100 degrees Celsius to the second predefined temperature of 250 degrees Celsius. The corresponding data is stored in a storage element 32 of the aerosol-generating device 10. Independent from the determined rate of increase in temperature of the electrical heater 18 during the first time period of the current experience, the controller 28 is configured to supply in a second time period of the current experience, electrical power from the power supply 26 to the electrical heater 18 according to a first heating profile in step 116 and to deliver the user experience. The first heating profile corresponds to a standard heating profile that is generally used at low ambient temperature conditions and is also used for aerosol-generating articles having a normal water content.

Steps 112 and 114 of determining and storing the required heat-up time of the electrical heater 18 may be omitted if the ambient temperature is determined to be below 18 degrees Celsius. Such omission reduces the amount of required controller operations, and thereby simplifies the design of the controller scheme.

If, at the start of the experience, the ambient temperature is above 18 degrees Celsius, the controller 28 determines the elapsed time since the previous user experience in step 106. If the elapsed time since the previous experience is above 180 seconds, the controller is arranged to supply electrical power from the power supply 26 to the electrical heater 18 for pre-heating the device and to continue at step 104 in the same way as discussed above.

If, however, the controller 28 determines in step 106 that the elapsed time since the previous user experience is below 180 seconds, the controller is arranged to check the rate of increase in temperature of the electrical heater 18 during the previous user experience. For this purpose the controller 28 reads out from the electronic storage element 32 of the aerosol-generating device 10, the stored time period that was determined and stored by the controller 28 in the previous user experience. If in the previous user experience the time taken to increase the temperature of the electrical heater 18 from 100 to 250 degrees Celsius was below 5.7 seconds, the aerosol-forming substrate 54 of the aerosol-generating article 52 is considered to have a normal water content. In this case the risk of the occurrence of a hot aerosol effect in a second user experience with the same aerosol-generating article 52 is considered to be low. Therefore the controller 28 continues with supplying electrical power to the electrical heater 18 for preheating (step 104) and delivering the user experience according to a first heating profile (step 116).

If the controller 28 determines in step 108 that during the previous user experience, the time taken to increase the temperature of the electrical heater 18 from 100 to 250 degrees Celsius was above 5.7 seconds, the aerosol-forming substrate 54 of the aerosol-generating article 52 is considered to have an increased water content. In this case the risk of the occurrence of a hot aerosol effect during the current user experience might be higher. In order to reduce the likelihood of the occurrence of the hot aerosol effect, the controller 28 prevents the supply of electric energy to the electrical heater 18, by forcing a time-out of the electrical heater 18 in step 110 and looping the controller 28 back to re-start the user experience. This procedure is repeated until the elapsed time since the previous user experience is determined in step 106 to be above 180 seconds. Once this timing threshold is reached, the controller 28 continues with supplying electrical power to the electrical heater 18 for preheating (step 104). This embodiment, in which a time-out period is included between two consecutive experiences and in which always the standard heating profile is applied, is envisioned in particular to be used in aerosol-generating systems, in which the occurrence of the hot aerosol effect is expected to be caused by an early consecutive experience rather than by an increased water content of the aerosol-forming substrate.

The operation of the controller 28 of the aerosol-generating device 10 as depicted in the diagram of FIG. 4 is largely identical to the one described in the context of FIG. 3. The main difference is that the controller 28 is arranged to choose the heating profile used in a current experience based on the determined rate of increase of the temperature of the electrical heater 18, which rate is determined in step 112. If the controller 28 determines in step 112 that the time required for the electrical heater 18 to be heated from the first predefined temperature of 100 degrees Celsius to the second predefined temperature of 250 degrees Celsius is below 5.7 seconds, the aerosol-forming substrate 54 of the aerosol-generating article 52 is considered to have a normal water content and the controller 28 chooses a standard heating profile in step 116.

If the controller 28 determines in step 112 that the time required for the electrical heater 18 to be heated from the first predefined temperature of 100 degrees Celsius to the second predefined temperature of 250 degrees Celsius is above 5.7 seconds, the aerosol-forming substrate 54 of the aerosol-generating article 52 is considered to have an increased water content and the controller 28 chooses a wet heating profile in step 118. In each case the required time At is stored in step 114 in a storage element 32. This parameter will be read out by the controller 28 in step 108 during the next user experience. If in step 108 it is determined that for the previous user experience the required time Δt_{prev exp} was above 5.7 seconds, a time-out of 180 seconds will be forced. If the stored parameter for Δt_{prev exp} is below 5.7 seconds, or no parameter Δt_{prev exp} is stored yet, the controller 29 continues with pre-heating the electrical heater 18.

The operation of the controller 28 of the aerosol-generating device 10 as depicted in the diagram of FIG. 5 includes an additional check in step 120 which is performed after step 108. If the controller 28 determines in step 106 that the elapsed time since the last experience is below 180 seconds and if the controller 28 further determines that in the previous experience the heating rate Δt_{prev exp} was above the predefined threshold, there is the possibility that the electrical heater 18 still is at an increased temperature. However, consistent aerosol generation might only be reliable obtained when the temperature of the electrical heater 18 is below a predefined temperature threshold. In the example of FIG. 5 the predefined temperature threshold is set at 80 degrees Celsius. If in step 120 it is determined that the current heater temperature T_{blade} is above this threshold, the controller 28 prevents power supply to the electrical heater 18. Once the temperature T_{blade} of the electrical heater 18 has dropped below the predefined temperature threshold, the controller starts preheating the electrical heater 18 in step 104 as described above in the context of FIGS. 3 and 4.

In FIGS. 6 to 8 a slightly different operation of the controller 28 is described. After initiation of the device and start of the experience, controller 28 again determines in a step 102 the ambient temperature using the temperature sensor 29. If the ambient temperature is below 18 degrees Celsius, electrical power is supplied from the power supply 26 to the electrical heater 18 according to the standard heating profile in step 116. If required, an additional preheating step 104 may be included as described above with FIGS. 3 to 5. After the experience is delivered to the user, the aerosol-generating device 10 is ready for a consecutive user experience.

If in step 102 the controller 28 determines that the ambient temperature is above 18 degrees Celsius, controller 28 continues with supplying electrical power to the electrical heater 18. If the controller 28 determines in step 112 that the time required for the electrical heater 18 to be heated from the first predefined temperature of 100 degrees Celsius to the second predefined temperature of 250 degrees Celsius is below 5.7 seconds, the aerosol-forming substrate 54 of the aerosol-generating article 52 is considered to have a normal water content and the controller 28 delivers the user experience according to a first heating profile (step 116). Again, after the experience is delivered to the user, the aerosol-generating device 10 is ready for a consecutive user experience.

If the controller 28 determines in step 112 that the time required for the electrical heater 18 to be heated from the first predefined temperature of 100 degrees Celsius to the second predefined temperature of 250 degrees Celsius is above 5.7 seconds, the aerosol-forming substrate 54 of the aerosol-generating article 52 is considered to have an increased water content. However, since the current experience is a first user experience the controller 28 nevertheless continues with delivering the user experience according to the standard heating profile in step 116. In contrast to the previous situation, after the experience is delivered to the user, the aerosol-generating device 20 is not ready for a consecutive user experience. Instead, since the controller 28 determined that the currently used aerosol-generating article 52 comprises aerosol-forming substrate 54 with increased water content, the controller 28 now forces a time-out of 180 seconds, before the next user experience can be started (step 122). The user may be informed of the need for the time-out directly at the end of the current user experience. For this purpose a user interface 34 in the form of a red LED is provided. The controller 28 activates the LED such that it is flashing throughout the time-out period. Once flashing of the LED stops, the next user experience may be started.

The operation of the controller 28 of the aerosol-generating device 10 as depicted in the diagram of FIG. 7 is largely identical to the one described in the context of FIG. 6. The main difference is that the controller 28 is arranged to choose the heating profile used in a current experience based on the determined rate of increase of the temperature of the electrical heater 18, which rate is determined in step 112. If the controller 28 determines in step 112 that the time required for the electrical heater 18 to be heated from the first predefined temperature of 100 degrees Celsius to the second predefined temperature of 250 degrees Celsius is above 5.7 seconds, the aerosol-forming substrate 54 of the aerosol-generating article 52 is considered to have an increased water content and the controller 28 may choose a wet heating profile in step 118, as indicated in the diagram of FIG. 7.

The operation of the controller 28 of the aerosol-generating device 10 as depicted in the diagram of FIG. 8 includes an additional check in step 120 which is in this case performed after checking the ambient temperature in step 102. If the controller 28 determines in step 102 that the ambient temperature is above 18 degrees Celsius, the controller 28 then determines in step 120 the current temperature of the electrical heater 18. If in step 120 it is determined that the current heater temperature T_{blade} is above the threshold temperature of 80 degrees Celsius, the controller 28 prevents power supply to the electrical heater 18. Once the temperature T_{blade} of the electrical heater 18 has dropped below the predefined temperature threshold, the controller starts supplying electric power to the electrical heater 18 as described above with respect to the diagram of FIG. 7.

1.-15. (canceled)

16. An aerosol-generating device, comprising:
a cavity configured to receive an aerosol-forming substrate;
an electrical heater arranged to heat the aerosol-forming substrate when the aerosol-forming substrate is received within the cavity, such as to provide a user an experience of inhalable aerosol;
a rechargeable power supply configured to provide at least a first experience and a second experience without intermediate recharge between the first experience and the second experience; and
a controller configured to
control a supply of power from the rechargeable power supply to the electrical heater,
determine a rate of increase in temperature of the electrical heater during a first time period of the first experience by determining a time taken for a temperature of the electrical heater to increase from a first predetermined temperature to a second predetermined temperature during the first time period of the first experience, and
prevent power being supplied to the heater in a second experience, if the rate of increase in temperature of the electrical heater during the first time period of the first experience is below a predefined rate threshold, and if the second experience is initiated before expiry of a predefined time interval from the first experience.

17. The aerosol-generating device according to claim 16,
wherein the controller comprises an electrical storage element, and
wherein the controller is further configured to store the rate of increase in temperature determined during the last experience.

18. The aerosol-generating device according to claim 16, wherein the controller is further configured to check the rate of increase in temperature and an elapsed time interval between the first experience and the second experience when the user is initiating the second experience.

19. The aerosol-generating device according to claim 16, wherein the controller is further configured to check the rate of increase in temperature at an end of the first experience.

20. The aerosol-generating device according to claim 19, wherein, if the controller determines that the rate of increase in temperature was below a predefined threshold, the user is alerted of a required time-out via a user interface.

21. The aerosol-generating device according to claim 20, wherein the user alert includes indicating to the user a duration of the time-out.

22. The aerosol-generating device according to claim 20, wherein the user alert includes visually indicating via an optical element throughout the time-out interval that the aerosol-generating device is not ready for the second experience.

23. The aerosol-generating device according to claim 22, wherein the controller is further configured to:
determine an initial temperature of the electrical heater, and
prevent power being supplied to the heater, if the initial temperature of the electrical heater is above a predefined temperature threshold.

24. The aerosol-generating device according to claim 23, wherein the temperature threshold is in a range from 60 degrees Celsius to 120 degrees Celsius.

25. The aerosol-generating device according to claim 23, wherein the temperature threshold is in a range from 80 degrees Celsius to 100 degrees Celsius.

26. The aerosol-generating device according to claim 23, wherein the temperature threshold is about 80 degrees Celsius.

27. The aerosol-generating device according to claim 16, wherein the controller is further configured to supply power from the power supply to the electrical heater according to a first heating profile during a second time period of each experience.

28. The aerosol-generating device according to claim 16, wherein the controller is further configured to adjust the supply of power from the power supply to the electrical heater based on the determined rate of increase in temperature of the electrical heater during the first time period of the first experience.

29. The aerosol-generating device according to claim 16, wherein the controller is further configured to supply power from the power supply to the electrical heater according to a second heating profile during a second time period of an experience, when the determined rate of increase in temperature of the electrical heater during the first time period of the experience is below the predetermined threshold.

30. The aerosol-generating device according to claim 16, wherein the controller is further configured to:
determine an ambient temperature, and
supply power from the power supply to the electrical heater according to the first heating profile when the determined ambient temperature is below an ambient temperature threshold.

31. An aerosol-generating system, comprising:
an aerosol-generating device according to claim 16; and
an aerosol-generating article comprising an aerosol-forming substrate.

32. A method of controlling an aerosol-generating device having a cavity configured to receive an aerosol-forming substrate, a rechargeable power supply, and an electrical heater configured to heat an aerosol-forming substrate when the aerosol-forming substrate is received within the cavity, such as to provide the user an experience of inhalable aerosol, the rechargeable power supply being configured to provide at least a first experience and a second experience without intermediate recharge between the first experience and the second experience, the method comprising the steps of:
controlling a supply of power from the power supply to the electrical heater;
determining a rate of increase in temperature of the electrical heater during a first time period of the first experience by determining a time taken for a temperature of the electrical heater to increase from a first predetermined temperature to a second predetermined temperature during the first time period of the first experience; and
preventing power being supplied to the heater in a second experience, if the rate of increase in temperature of the electrical heater during the first time period of the first experience is below a predefined rate threshold, and if the second experience is initiated before expiry of a predefined time interval from the first experience.
